(19) United States
(12) Patent Application Publication
(10) Pub. No.: US 2024/0330745 A1
(43) Pub. Date: Oct. 3, 2024

(54) OPTIMAL RELAXED CLASSIFICATION TREES

(71) Applicant: INTERNATIONAL BUSINESS MACHINES CORPORATION, Armonk, NY (US)

(72) Inventors: Shivaram Subramanian, Frisco, TX (US); Wei Sun, Scarsdale, NY (US)

(21) Appl. No.: 18/192,613

(22) Filed: Mar. 29, 2023

(51) Int. Cl. G06N 20/00

(52) U.S. Cl. CPC G06N 20/00

(57) ABSTRACT

A method for generates an interpretable predictive model using relaxed classification trees includes receiving, by a processor, a set of data and one or more constraints to be applied to the set of data. The set of data, under the one or more constraints, is processed in a machine learning model. The operation of the machine learning model includes generating a hierarchical feature graph classifying the data points. A plurality of classification rules applicable to the data points are discovered using a linear or quadratic program problem. A weighted value is assigned to each rule applied to the data points, to generate weighted classification rules. A combination of the weighted rules is assigned to a plurality of the data points. Interpretable classification trees are generated from the data points based on the combination of weighted classification rules of respective data points.

### BACKGROUND

### Technical Field

The present disclosure generally relates to computing arrangements using knowledge-based models, and more particularly, to optimal relaxed classification trees.

### Description of the Related Art

To assist computing platforms in predicting probabilistic outcomes, decision trees are commonly used as a tool. In a conventional decision tree, each sample is assigned to a single leaf node. A decision tree is among the most popular machine learning and artificial intelligence methods, largely due to its interpretability. Commonly, decision trees use quick, greedy heuristics to come up with queries from the input data. One example of a decision tree technique is a classification and regression tree (CART). While using CART may provide quick results, there is no guarantee of the optimality of the results generated. The quality of the CART decision tree is usually unknown.

Decision trees in general may also lack the ability to factor in constraints that affect the predicted behavior of input data. Some approaches may use historical training data that does not account for constraints outside of the general premises programmed for a particular application. So typically, by adding a variety of constraints to a model, the outcome may suggest disallowing certain combinations. However, outcomes factoring in constraints are currently fairly inaccurate because the type of programming including constraints is limited.

Recently, mixed integer programming (MIP) approaches have been proposed to construct optimal classification trees (OCTs) which demonstrate higher prediction accuracy over CART. A mixed-integer programming problem is one where some of the decision variables are constrained to be integer values. Each sample is assigned to exactly a single decision rule in this kind of an approach. In the context of one application, for example, the predicted class could be based on a particular attribute. The benefit to an MIP approach is that an MIP is convenient to handle a variety of constraints. However, the current MIP approaches do not perform well with a large training sample of data. An MIP may take hours to process the same data set that a CART system can do in minutes.

When solving an MIP problem, there may be hundreds of thousands of data points and every point may need to be mapped to exactly one of the rules. In another sense, all the training data and sample data may be exactly partitioned across all the different rules. The partitioning of the dataset of all the samples across the rules becomes a discreet optimization problem, which is known to involve a substantial amount of computing resources and/or time.

Other newer methods include the use of ensemble trees. Different decision trees are combined in some smart manner to significantly boost the accuracy of the results. The ensembles generally include well-known decision tree techniques that may typically be used alone, such as, the random forest and gradient boosted tree. Individually, the ensemble type decision tree techniques produce good accuracy but cannot computationally handle the inclusion of constraints.

### SUMMARY

In general, the embodiments, provide an improvement over computational resources and speed of output in providing machine learning based modeling. The embodiments generally provide classification tree generation that uses weighted rules so that classification of data points can provide more than one output for a data point. The requirement to partition data points exactly into one rule is eliminated. The classification trees of the embodiments disclosed below provide flexible modeling that balances accuracy with runtime processing.

According to an embodiment of the present disclosure, a computer program product for generating interpretable weighted classification trees is disclosed. The computer program product includes one or more computer readable storage media, and program instructions collectively stored on the one or more computer readable storage media. The program instructions include receiving, by a processor, a set of training data and one or more constraints to be applied to the set of training data. The set of training data is processed under the one or more constraints, in a machine learning model. An operation of the machine learning model includes generating a hierarchical feature graph classifying data points in the set of training data. A plurality of classification rules applicable to the data points is discovered using a linear program problem or a quadratic program problem. A weighted value is assigned to each rule applied to the data points, to generate weighted classification rules. A combination of the weighted rules is assigned to a plurality of the data points. Interpretable classification trees are generated from the data points based on the combination of weighted classification rules of respective data points.

Some embodiments use a linear program or quadratic program problem to generate the rules for classifying the data points. The linear and quadratic problems, when combined with the weighted rules for classification, provide an improvement over other classification methods because linear and quadratic problems can handle constraints while being processed faster than other problem-based approaches including, for example, mixed integer programming.

According to an embodiment of the present disclosure, a method for generating interpretable weighted classification trees is provided. The method includes receiving, by a processor, a set of training data and one or more constraints to be applied to the set of training data. The set of training data is processed under the one or more constraints, in a machine learning model. An operation of the machine learning model includes generating a hierarchical feature graph classifying data points in the set of training data. A plurality of classification rules applicable to the data points is discovered using a linear program problem or a quadratic program problem. A weighted value is assigned to each rule applied to the data points, to generate weighted classification rules. A combination of the weighted rules is assigned to a plurality of the data points. Interpretable classification trees are generated from the data points based on the combination of weighted classification rules of respective data points.

According to one embodiment, the method may factor in the use of inter-rule and intra-rule constraints. As may be appreciated, other approaches such as mixed integer programming are limited when using constraints in solving classification problems. For example, mixed integer programming may presently only use additive linear expressions. The subject method is not limited to linear expressions and can provide more accurate results factoring in the inter and intra rule constraints. Customers will be provided with improved data that is more accurate to real-life factors that are reflected by the constraints.

According to an embodiment of the present disclosure, a computing device for generating interpretable weighted classification trees is disclosed. The computing device includes a processor and a memory coupled to the processor. The memory stores instructions to cause the processor to perform acts including receiving, by the processor, a set of data and one or more constraints to be applied to the set of data. The set of data, under the one or more constraints, is processed in a machine learning model. The operation of the machine learning model includes generating a hierarchical feature graph classifying the data points. A plurality of classification rules applicable to the data points are discovered using a linear or quadratic program problem. A weighted value is assigned to each rule applied to the data points, to generate weighted classification rules. A combination of the weighted rules is assigned to a plurality of the data points. Interpretable classification trees are generated from the data points based on the combination of weighted classification rules of respective data points.

According to one embodiment, the method includes optimizing the linear or quadratic program problem to discover classification rules prioritizing one of a misclassification error value or a purity value for rule discovery. A user is able to manipulate the classification tree output so that accuracy is prioritized or a reduced number of rules are applied to a data point for ease of interpretation.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a computing environment for generating weighted classification trees according to an embodiment.

FIG. 2 is a block diagram of an architecture for generating weighted classification trees according to an embodiment.

FIG. 3 is a block diagram of a method for generating interpretable weighted classification trees according to some embodiments.

FIG. 4 is a plot of a hierarchical feature graph consistent with embodiments.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Definitions

Decision Tree: a decision support tool that uses a tree-like model of decisions and their possible consequences, including chance event outcomes, resource costs, and utility.

Predictive Model: a process used to predict future events or outcomes by analyzing patterns in a given set of input data.

### Overview

The present disclosure generally relates to systems and methods for producing machine learning (ML) or artificial intelligence (AI) based predictive modeling that is scalable with increasing size data sets, includes high interpretability, and can handle the inclusion of constraints. The model may include a weighted combination of decision rules. In some embodiments, the sum of weights equals 1. The rule selection problem for the predictive model may be written as a linear programming (LP) problem or quadratic programming problem, either of which can be solved more efficiently than a MIP. It will be appreciated that a model using a weighted combination of decision rules can be optimal by design. If, for example, a warm start with a tree solution (e.g., CART or a MIP OCT solution) is used, the proposed method of the subject disclosure is likely to outperform the accuracy of the previous solutions in training. Moreover, it will be appreciated that constraints can be easily incorporated into the LP or quadratic formulation while maintaining accuracy and a speedy computation of results.

In comparison to a computing device using a mixed integer optimization model, which is computationally complex, the subject methods provide substantially more accurate results in much less time. For most instances using an MIP, good quality solutions can be found—but an MIP can be time inefficient, which presents a different challenge. As each sample is assigned to exactly a single decision rule in an MIP, the model may reveal that the predicted class would be, for example, for a particular attribute. The model evaluates the majority class of the samples and the leaf node. The MIP model may determine that the majority of samples are exhibiting one attribute. The MIP model would assign to the samples a majority-based rule.

The subject method and modeling can produce and use multiple decision rules. A model using a weighted combination of decision rules can interpret the above scenarios and determine that a user of a computing interface might be flying somewhere, and if they are going on a flight, the user may be travelling in different contexts. The weighted combination of rules may treat the user data point as probabilistic; determining for example that the user may have a 50% of exhibiting one attribute, and another 50% chance that the user exhibits another attribute. While 50% was just used as an example, it should be understood that the probabilities may include classification into more segments than two. Accordingly, the probabilities may be other than 50% for the different rules. As can be seen, the weighted rules in the proposed modeling generate different ways for the different rules to calculate a final classification. Yet, the throughput runtime inefficiencies associated with MIP can be eliminated because the proposed model and process are able to use linear or quadratic programming, which are faster than traditional MIP problem computing processes. As may be appreciated, the benefit of using a weighted combination of rules process provides an improvement in computer technology since the underlying process allows the computer to run more efficiently.

For example, since embodiments of the instant disclosure use a weighted combination of rules for modeling, the process is no longer restricted to just determining an exact partition placing data points into exactly one segment for one tree, but instead can work with multiple trees. Accordingly, the challenge of having to place a data point into an exact classification is removed. So now the computer no longer needs to solve this discreet optimization problem that is associated with MIP based systems. The computer can solve the data sample as a linear programming problem. If an administrative user setting up the model wants to minimize scatter or some other metric, the model may be set up to solve a quadratic programming problem, both of which (linear and quadratic problems) are classified as complex problems that are very well defined. As may be expected, the runtime of either programming problem is predictable and likely to terminate in a reasonable amount of time and the process is going to converge fairly quickly.

It should be further appreciated that the teachings herein can be compatible with previously used methods (for example, CART), to help supplement the results and improve runtime efficiency. For example, an administrative user may program into the model the rules using CART or another method to jumpstart the solution to speed up runtime even more.

In applications that involve constraints, such as constraints and rules, rather than generating a tree and then performing some pre-processing, previous methods may involve one to determine whether the rules meet predetermined requirements. When the rules do not meet the predetermined requirements, the administrative user may be forced to go back and adjust the trees in iterations to identify something that satisfies the rules and the constraints. The subject method incorporates constraints while constructing the tree. Accordingly, classification throughput is sped up because the prior entire pre-processing computing step associated with singular tree models is now moot since the constraints are already part of the initial parameters for setting up the model.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the improved interpretable prediction code 200. The improved interpretable prediction code 200 may include a plurality of code sub-programs or modules. For example, some embodiments include a rule discovery engine 240, a rule weighting engine 244, a classification training model 246, and a classification prediction model 248. The rule discovery engine 240 may include code that identifies rules associated with data points during a classification process. As will be explained in further detail below, multiple rules may be combined during classification of a data point. The rule weighting engine 244 includes code that applies a weighting value to an identified rule. The rule weighting engine 244 may adjust the weighting value to rules upon discovery of new rules applied to a data point. The classification training model 246 includes code that generates training of a model using a data set. The classification prediction model 248 includes code that generates predictions from the fitted model generated by the classification training model 246. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

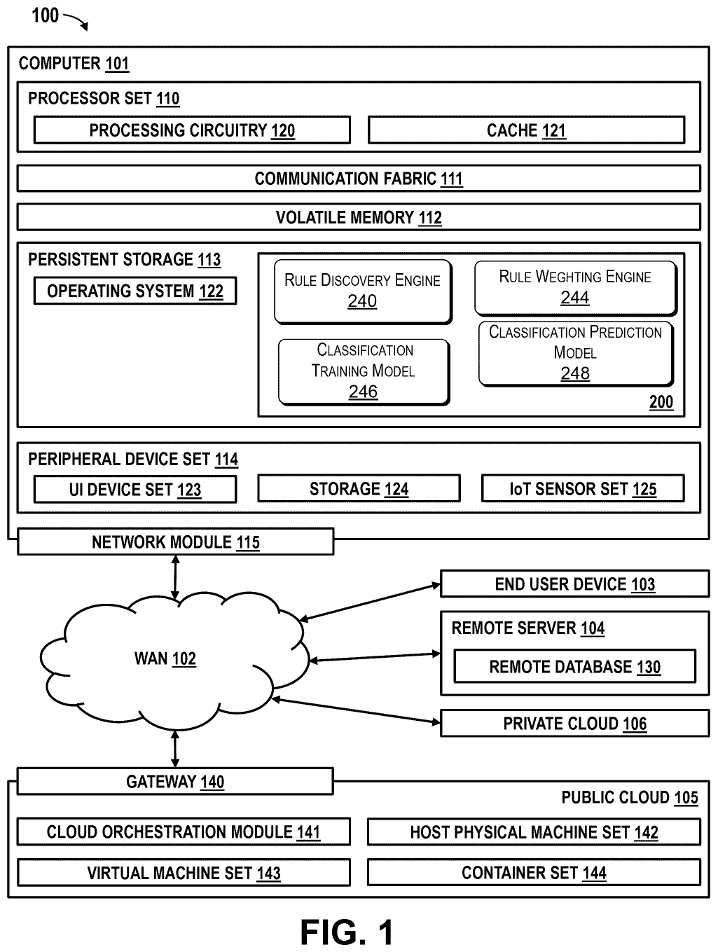

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example System Architecture

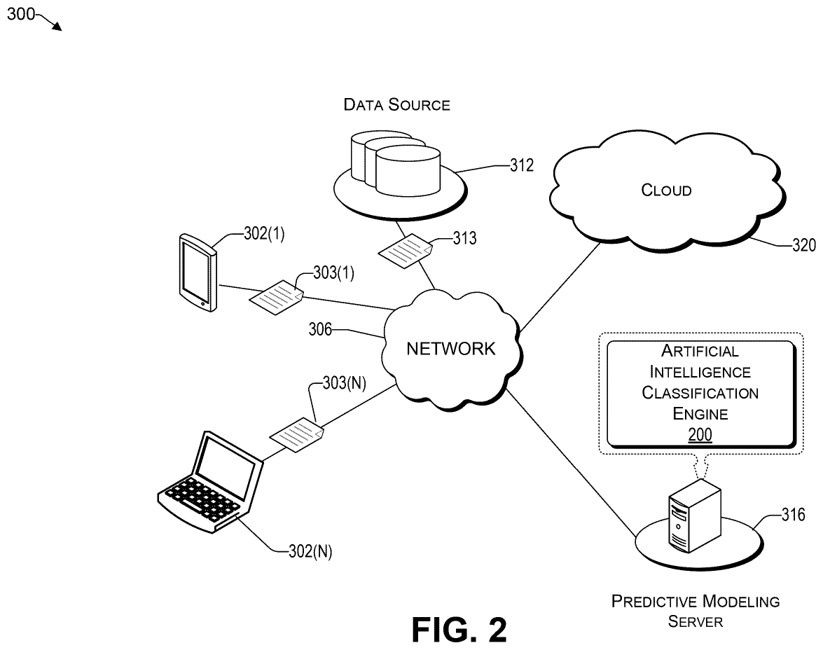

FIG. 2 illustrates an example architecture 300 for predictive modeling using a weighted combination of rules. Architecture 300 includes a network 306 that allows various computing devices 302(1) to 302(N) to communicate with each other, as well as other elements that are connected to the network 306, such as data source 312, a predictive modeling server 316, and the cloud 320. The computing devices 302(1) to 302(N) and predictive modeling server 316 may operate under the computing environment described above in FIG. 1.

The network 306 may be, without limitation, a local area network (“LAN”), a virtual private network (“VPN”), a cellular network, the Internet, or a combination thereof. For example, the network 306 may include a mobile network that is communicatively coupled to a private network, sometimes referred to as an intranet that provides various ancillary services, such as communication with various application stores, libraries, and the Internet. The network 306 allows an A.I. classification engine 310, which is a software program running on the predictive modeling server 316, to communicate with the data source 312, computing devices 302(1) to 302(N), and/or the cloud 320, to provide data processing. The data source 312 may include training data and data samples that will be processed under one or more techniques described here. In some embodiments, a data packet 313 may be received by the A.I. classification engine 310. This data packet 313 can be received by the A.I. classification engine 310 by either a push operation from the database 312 or from a pull operation of the A.I. classification engine 310. In one embodiment, the data processing is performed at least in part on the cloud 320.

For purposes of later discussion, several user devices appear in the drawing, to represent some examples of the computing devices that may be the source of data being analyzed depending on the task chosen. Aspects of the symbolic sequence data (e.g., 303(1) and 303(N)) may be communicated over the network 306 with the A.I. classification engine 310 of the predictive modeling server 316. Today, user devices typically take the form of portable handsets, smart-phones, tablet computers, personal digital assistants (PDAs), and smart watches, although they may be implemented in other form factors, including consumer, and business electronic devices.

For example, a computing device (e.g., 302(1)) may send a request 303(N) to the A.I. classification engine 310 to classify for example, different objects represented by the data samples.

While the data source 312 and the A.I. classification engine 310 are illustrated by way of example to be on different platforms, it will be understood that in various embodiments, the data source 312 and the predictive modeling server 316 may be combined. In other embodiments, these computing platforms may be implemented by virtual computing devices in the form of virtual machines or software containers that are hosted in a cloud 320, thereby providing an elastic architecture for processing and storage.

### Example Methodology

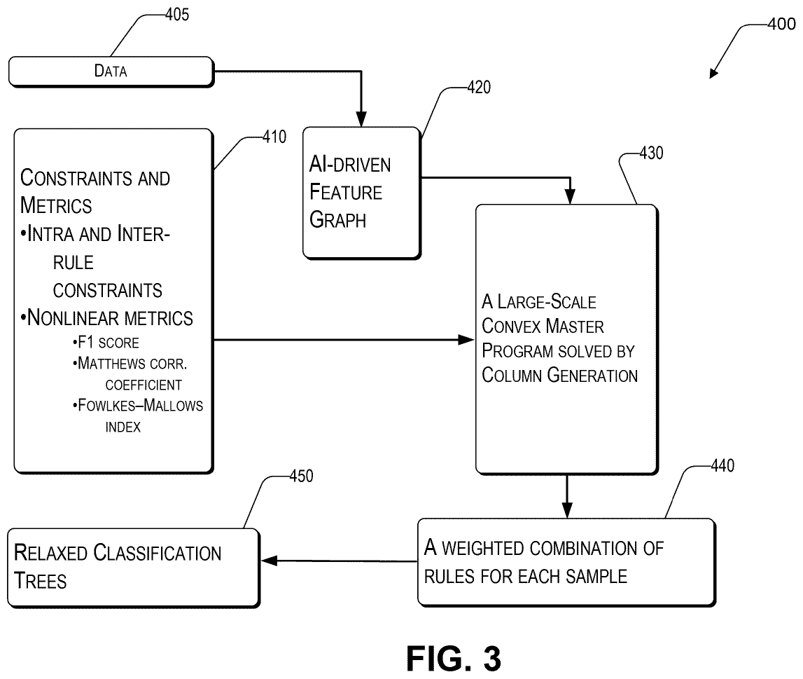

Reference now is made to FIG. 3. A computer implemented process 400 for classifying data using relaxed classification trees is shown according to an illustrative embodiment. The following steps may be performed by a computer processor. In one aspect, the present disclosure presents a scalable column generation framework to provide solutions to decision tree problems by providing an optimal multiway-split tree (OMT) which is more interpretable and informative than typical binary-split trees due to using a combination of weighted rules applied to each node. For example, the framework is able to assign more than one rule to a data point. The weighting of each rule applied to a data point may represent probabilistic value of the accuracy in classification of the data point. As used herein, the term “multiway” tree when referring to decision trees and/or split trees is to be understood as being able to have more than two children.

The process 400 generally includes retrieving data 405 from a database (for example, the data source 312 of FIG. 2). The retrieved data may be training data or data samples (which may represent for example, an attribute) to be classified. The data 405 may include transactions in the training data, such as a list of features sorted in order of importance suggested by any black box prediction model. In block 410, the processor may receive a set of constraints to consider. A performance requirement according to one or more metrics may be specified to evaluate the performance of the predictive model. The constraints may include inter and intra rule constraints. The metrics may include non-linear types of metrics (for example, an F1 score, a Matthews correlation coefficient, and/or a Fowlkes-Mallows index).

In block 420, an AI-driven feature graph may be constructed from processing the input data. The feature graph embeds the hierarchical structure of a tree, and constraints are added to model a property of decision trees. Details of how to construct a feature graph under the present disclosure are provided below. In block 430, the processor may apply an optimization program to the feature graph and input data to solve the classification problem that includes the constraints from block 410. In one embodiment, a large-scale convex master program may be used to solve the feature space by using column generation. In block 440, the processor applies a weighted combination of rules to one or more of the samples. By using a combination of rules, an attribute may appear more than once in a tree. In one embodiment, the sum of weighting for the rules applied to a single sample data point equals 1. When weighted combination of rules are applied to a sample data point, the optimization program may first determine rule candidates that may fit the sample data point. The determination of rules to apply to a sample data point under classification may use metrics to select a rule. The metrics may be used to guide the processor in iteratively searching for new rules. Then the optimization program may determine how much weight to give each rule applied to the sample data point being classified. While the following is described in the context of classification, it should be understood that the process disclosed may be used for regression applications as well.

### Example AI Feature Driven Graph

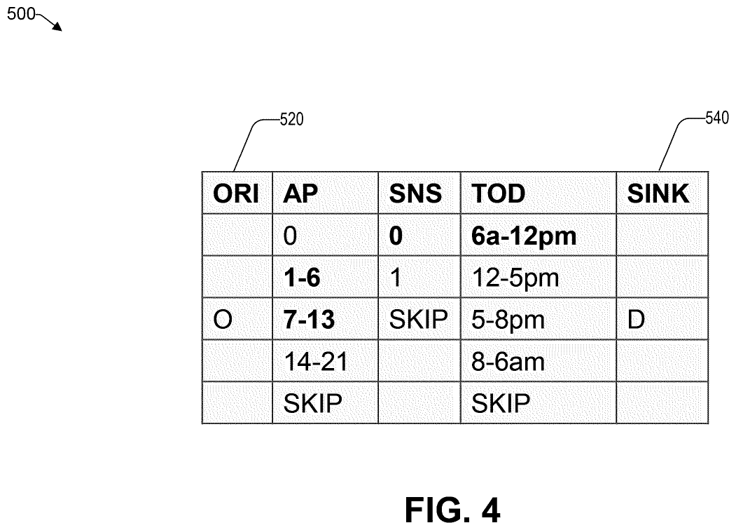

Referring now to FIG. 4, an AI feature driven, hierarchical graph 500 (referred to herein in short as the “graph 500”) is shown according to an illustrative embodiment. By way of example only and not by way of limitation, the graph 500 represents potential transactions by customers associated with purchasing a travel ticket. In the graph 500, data points (feature values) are being grouped under different columns. A list of features may be sorted in order of importance suggested (e.g., derived) by a black-box prediction model (for example, based on SHapley Additive exPlanations (SHAP) scores). Column “AP” represents an advance purchase. Column “SNS represents a Saturday night stay. Column “TOD” represents a Time-of-day. The source node is represented by “O”. The sink node is labeled “SINK”. It should be noted that the arrows in graph 500 represent directed (e.g., one-way) arcs connecting two nodes. In the feature graph 500 of FIG. 4, there are directed arcs between the nodes corresponding to successive feature layers. In the subproblem, traverse through these arcs is facilitated and progress from source-to-sink to create paths (i.e., decision rules).

Given a feature f, the process of generating the feature graph 500 may include creating a node for each distinct feature value, L_{f}. The last node (level L_{f-1}) denotes a ‘SKIP’ node. When a path passes thru “SKIP”, then the feature f is not part of the rule/policy. In one embodiment, numerical features along with discretized and cumulative bins are stored symbolically. This step is a computational advancement over previous techniques. For example, previous techniques that did not use weighted combination of rules operated with smaller feature sets and were less scalable as a result. However, as feature sets become larger, the discretized values generate thousands of nodes. Having so many nodes representing different rules becomes impractical as a tool for interpreting data when displayed on a user interface. A user viewing the display may become unsure of how to treat the information. When discretizing numerical values under the subject disclosure, the discretization will create bin values and the rule generating process involves combinations of values. The graph generating process may use symbolic processing to represent the combinations of values to sort data points into the graph 500, resulting in many less nodes displayed.

A source node “O” and a sink node “s” are created. A node set FROM={o} and the feature index f=0 may be created. The process may run until the condition “FROM” is not EMPTY. The process may connect FROM nodes to TO nodes by directed arcs. The process may Add to Arc set A: {ni,f} X {nj,f+1}, for all i, j. The variable “X” denotes all possible combinations. If the feature index f=N−1, the TO node=SINK ‘s’. If the feature index f<N,f=f+1. The feature graph consists of feature nodes (and a designated source and sink node). These nodes are connected buy arcs as follows. ‘nᵢ’ denotes node ‘i’, where i is the node index. We create directed arcs from all nᵢ of a feature f to all node n; belong to the next feature (f+1), i.e., all possible connections between successive layers of nodes. ‘N’ denotes the number of feature index values. Such a scheme produces a sparse directed acylic digraph (i.e, a directed graph that contains cycles) Otherwise, the process may STOP and Return Arc set A.

The total Number of nodes in the graph 500 may=Σ_{f} L_{f}+2, Arcs=Σ_{f}(L_{f}*L_{f+1}). The total number of feasible paths/rules using the instant graph generation process=Π_{f} L_{f}

### Example Optimization Program

Referring still to FIG. 4, generally speaking, the optimization program process is solving two problems that are intertwined; a master problem and a sub-problem. The sub-problem is continuously searching for candidate rules. The master problem combines the candidate rules to determine what weight should be given to each rule for a data point. And to find improved candidate rules, thereby providing an iterative procedure. So, the sub problem goes through the network. As one can see, the graph 500 includes an origin 520 and a sink 540 and there are different paths that are possible from the origin to the sink. The sub-problem searches through the graph to find improved candidate rules, and provides the candidate rules to the master program. The master program takes all the candidate rules and generates numerical metrics to guide the next iterations searching for improved rules. In some embodiments, a user interface for setting up the model may include a selectable feature that allows the programmer to select between running the optimization program as either a linear program or a quadratic program. The following is an example set of parameters for operating an optimization program under the subject disclosure.

### Coefficients

Incidence matrix aᵢⱼ=1 if features in rule j are present in sample i

Coverage Penalty cᵢ=big enough penalty to force every observation to be covered by a classification rule
I(i) is the true label (class) of sample i
κ_{f}^{I(i)} is the corresponding proportion of class I(i) in rule j
Gini index of rule j, gⱼ. As a measure of impurity or purity of a rule a smaller value may be preferred.

β=1 corresponds to a Linear programming (LP) problem, and β=2 corresponds to a quadratic programming (QP) problem.

$$( WOMT ) min {\vert δ \vert}^{β} + {\sum }_{i = 1}^{N} {c}_{i} {s}_{i} + γ {\sum }_{j = 1}^{L} {g}_{j} {z}_{j} \\ s . t . {\sum }_{j = 1}^{L} {a}_{ij} {z}_{j} + {s}_{i} = 1 , ∀ i = 1 , … , N . \\ {\sum }_{j = 1}^{L} {a}_{ij} {κ}_{j}^{I ( i )} {z}_{j} + {δ}_{i} = 1 ∀ i = 1 , … , N . \\ 0 \leq {z}_{j} \leq 1 , ∀ j = 1 , … , L . \\ {s}_{i} \geq 0 , ∀ i = 1 , … , N .$$

In some embodiments, the model may try to minimize a selected metric. For example, some embodiments include a user selected input that requests minimizing the amount of classification error involved when applying rules. Minimizing some type of error is represented by the “c” and “g” terms in the equations above. In some embodiments, the model may control the purity of rules generated by minimizing the number of rules applied to a sample data point. The level of purity is governed by the gamma term in the equations above. An ensemble decision tree of high purity would be a solution where each data sample is assigned to as few rules as possible. As may be appreciated, the optimization process may allow users to adjust or optimize the results to value minimizing error or purity more. For example, a threshold metric value may indicate that the optimization program will discard or ignore some rules whose probability value for a sample data point are too low. This may generate better interpretable results that can be explained to a customer. The choice of β=1 or 2.0 depends on the user's preference to minimize median error or squared error, respectively. We recommend a default value of 2.0.

For example, while a sample data point representing one type of customer may fall into several categories, it may be more productive to interpret from the results that the type of object represented by a data sample is most likely to behave under just a few rules that seem more probabilistic than trying to explain how the same object type may sometimes, while unlikely, also exhibit other lower probability behavior. The preceding scenario represents the subject process' ability to provide the fewest number of trees with the best accuracy. The optimization program of the subject disclosure takes any value between 0 and 1, which is a key change from previous binary classification techniques. The weighting value is dynamically calculated within the algorithm and applied to a data point and allows the modeling to use complex programs and become more scalable for processing of larger data sets.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail above, the operational/functional language is to be read in its proper technological context, i.e., as concrete specifications for physical implementations.

Accordingly, one or more of the methodologies discussed herein may obviate a need for time consuming data processing by the user. This may have the technical effect of reducing computing resources used by one or more devices within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer program product for generating interpretable weighted classification trees, the computer program product comprising:
one or more computer readable storage media, and program instructions collectively stored on the one or more computer readable storage media, the program instructions comprising:
receiving, by a processor, a set of training data and one or more constraints to be applied to the set of training data; and
processing the set of training data under the one or more constraints, in a machine learning model, wherein an operation of the machine learning model includes:
generating a hierarchical feature graph classifying data points in the set of training data;
discovering a plurality of classification rules applicable to the data points using a linear program problem or a quadratic program problem;
assigning a weighted value to each rule applied to the data points, to generate weighted classification rules;
assigning a combination of the weighted rules to a plurality of the data points; and
generating interpretable classification trees from the data points based on the combination of weighted rules of respective data points.

2. The computer program product of claim 1, wherein the program instructions further comprise:
in response to receiving the set of training data, sorting, by a computer, a list of features associated with the set of training data in an order of importance based on a score derived from a black-box prediction model;
given a feature f, creating a node for each distinct feature value, L_{f}, wherein:
a last node L_{f-1} denotes a SKIP node,
a path passes thru the SKIP node,
the feature f is not part of a rule, and
numerical features, and discretized and cumulative bins are stored symbolically;
creating a source node o and a sink node s;
generating a node set FROM={o}, wherein a feature index f=0; and
connecting the node set FROM to one or more TO nodes by directed arcs, and adding to an arc set A: {ni,f} X {nj,f+1}, for all i, j, and if f=N−1, TO node=SINK s, and if f<N,f=f+1, else STOP and Return the arc set A;
wherein a total number of nodes=Σ_{f} L_{f}+2, Arcs=Σ_{f}(L_{f}*L_{f+1}); and
wherein total feasible rules=Π_{f}L_{f}.

3. The computer program product of claim 2, wherein the program instructions further comprise:
generating an incidence matrix aᵢⱼ=1 if features in rule j are present in sample i; and
including in the generation of the hierarchical feature graph, a coverage penalty cᵢ to force each observation to be covered by a classification rule;
wherein I(i) is a true label class of sample i;
wherein κⱼ^{I(i)} is a corresponding proportion of class I(i) in rule j; and
wherein a Gini index of rule j, gⱼ is measuring impurity and purity of a rule.

4. The computer program product of claim 3, wherein β=1 corresponds to the linear programming problem and β=2 corresponds to the quadratic programming problem.

5. The computer program product of claim 1, wherein the program instructions further comprise generating optimal multiway split regression trees including coefficients.

6. The computer program product of claim 1, wherein the program instructions further comprise factoring in one or more inter-rule and intra-rule constraints in generating the hierarchical feature graph.

7. The computer program product of claim 1, wherein a total value of weighted values assigned to rules applied to a data point equals 1.

8. A method for generating interpretable weighted classification trees, comprising:
receiving, by a processor, a set of training data and one or more constraints to be applied to the set of training data; and
processing the set of training data under the one or more constraints, in a machine learning model, wherein an operation of the machine learning model includes:
generating a hierarchical feature graph classifying data points in the set of training data;
discovering a plurality of classification rules applicable to the data points using a linear program problem or a quadratic program problem;
assigning a weighted value to each rule applied to the data points, to generate weighted classification rules;
assigning a combination of the weighted rules to a plurality of the data points; and
generating interpretable classification trees from the data points based on the combination of weighted classification rules of respective data points.

9. The method of claim 8, further comprising:
in response to receiving the set of training data, sorting, by a computer, a list of features associated with the set of training data in an order of importance based on a score derived from a black-box prediction model;
given a feature f, creating a node for each distinct feature value, L_{f}, wherein:
a last node L_{f-1} denotes a SKIP node,
a path passes thru the SKIP node,
the feature f is not part of a rule, and
numerical features, and discretized and cumulative bins are stored symbolically;
creating a source node o and a sink node s;
generating a node set FROM={o}, wherein a feature index f=0; and
connecting the node set FROM to one or more TO nodes by directed arcs, and adding to an arc set A: {ni,f} X {nj,f+1}, for all i, j, and if f=N−1, TO node=SINK s, and if f<N,f=f+1, else STOP and Return the arc set A;
wherein a total number of nodes=Σ_{f} L_{f}+2, Arcs=Σ_{f}(L_{f}*L_{f+1}); and
wherein total feasible rules=Π_{f}L_{f}.

10. The method of claim 9, further comprising:
generating an incidence matrix aᵢⱼ=1 if features in rule j are present in sample i; and
including in the generation of the hierarchical feature graph, a coverage penalty cᵢ to force each observation to be covered by a classification rule;
wherein I(i) is a true label class of sample i;
wherein κⱼ^{I(i)} is a corresponding proportion of class I(i) in rule j; and
wherein a Gini index of rule j, gⱼ is measuring impurity and purity of a rule.

11. The method of claim 9, wherein β=1 corresponds to the linear program problem and β=2 corresponds to the quadratic program problem.

12. The method of claim 8, further comprising generating optimal multiway split regression trees including coefficients.

13. The method of claim 8, further comprising factoring in one or more inter-rule and intra-rule constraints in generating the hierarchical feature graph.

14. The method of claim 8, wherein a total value of weighted values assigned to rules applied to a data point equals 1.

15. A computing device for generating an interpretable predictive model, comprising:
a processor;
a memory coupled to the processor, the memory storing instructions configured to cause the processor to perform acts comprising:
receiving, by a processor, a set of data and one or more constraints to be applied to the set of data; and
processing the set of data under the one or more constraints, in a machine learning model, wherein an operation of the machine learning model includes:
generating a hierarchical feature graph classifying the data points;
discovering a plurality of classification rules applicable to the data points using a linear or quadratic program problem;
assigning a weighted value to each rule applied to the data points, to generate weighted classification rules;
assigning a combination of the weighted rules to a plurality of the data points; and
generating interpretable classification trees from the data points based on the combination of weighted classification rules of respective data points.

16. The computing device of claim 15, wherein the instructions cause the processor to perform an additional act comprising assigning an error value threshold to the linear program problem or to the quadratic program problem.

17. The computing device of claim 15, wherein the constraints are inter-rule and intra-rule constraints.

18. The computing device of claim 15, wherein the instructions cause the processor to perform an additional act comprising including a purity value threshold for discovering classification rules in the linear program problem or in the quadratic program problem.

19. The computing device of claim 15, wherein the instructions cause the processor to perform an additional act comprising optimizing the linear program problem or the quadratic program problem to discover classification rules prioritizing one of a misclassification error value or a purity value for rule discovery.

20. The computing device of claim 15, wherein a total value of weighted values assigned to rules applied to a data point equals 1.
